(19) United States
(12) Patent Application Publication
(10) Pub. No.: US 2016/0169371 A1
(43) Pub. Date: Jun. 16, 2016

(54) MULTIFUNCTIONAL BEARING RINGS FOR LIGHTWEIGHT DIFFERENTIALS HAVING AN EMBRACING CHANNEL

(71) Applicant: SCHAEFFLER TECHNOLOGIES AG & CO. KG, Herzogenaurach (DE)

(72) Inventors: Harald Martini, Herzogenaurach (DE); Thorsten Biermann, Wachenroth (DE)

(73) Assignee: Schaeffler Technologies GMBH & Co. KG, Herzogenaurach (DE)

(21) Appl. No.: 14/907,978

(22) PCT Filed: Jun. 30, 2014
(86) PCT No.: PCT/DE2014/200289

§ 371 Date: Jan. 27, 2016

(30) Foreign Application Priority Data
Aug. 12, 2013 (DE) 102013215871.8

(51) Int. Cl. F16H 57/08; F16H 48/10

(52) U.S. Cl. CPC F16H 57/08; F16H 48/10; F16H 2048/106; F16H 2057/085

(57) ABSTRACT

A planetary gearbox such as a differential gearbox, having a planet carrier, to which planet wheels, which interengage with at least one sun wheel, are rotatably attached, wherein the planet carrier can be connected to a drive wheel, such as a face gear, wherein furthermore a rolling-contact bearing having rolling elements and comprising two bearing rings, namely an inner bearing ring and an outer bearing ring, rotatably supports the planet wheel on a stationary housing, such as a gearbox housing, in a manner determining the position axially and/or radially, wherein at least one of the bearing rings forms a raceway for the rolling elements to roll thereon, wherein the inner bearing ring has a channel to embrace a carrier element, such as a section of the housing or of the planet carrier.

### CROSS-REFERENCE TO RELATED APPLICATIONS

The present application is the United States National Stage Application pursuant to 35 U.S.C. §371 of International Patent Application No. PCT/DE2014/200289, filed on Jun. 30, 2014, and claims priority to German Patent Application No. DE 10 2013 215 871.8, filed Aug. 12, 2013, which applications are incorporated by reference in their entireties.

### FIELD OF THE INVENTION

The invention relates to a planetary gear unit, such as a differential transmission, with a planet carrier, which could also be referred to as a differential cage and to which planet gears, which are in meshing engagement with at least one sun gear, are rotatably connected, wherein the planet carrier can be connected to a drive gear, such as a spur gear, wherein, furthermore, a rolling bearing having rolling bodies and two bearing rings, i.e., an inner bearing ring and an outer bearing ring, rotatably mounts the planet carrier on a stationary housing, such as a transmission housing, in such a way that said rolling bearing determines the axial and/or radial position, wherein at least one of the bearing rings forms a rolling raceway for the rolling bodies to roll thereon.

The planet carrier may also be referred to as a cage; in particular, it may be designed as a differential cage.

### BACKGROUND OF THE INVENTION

A number of planetary gear units are already known from the prior art, such as, for example, from the patent EP 0156067.

In principle, differential gear units for motor vehicles are known from the patent DE 10156890 C1, where a differential gear unit is disclosed for a motor vehicle with a differential housing, which is mounted in a housing wall and has a drive sprocket. A differential pin is arranged with at least one rotatably mounted differential bevel gear, in said differential housing; and this differential bevel gear is engaged with a drive shaft gear of a drive shaft mounted in the differential housing.

The drive shaft is mounted by means of at least one first bearing in the housing wall of the differential gear unit and/or of the differential housing by means of at least one second bearing on the drive shaft, and the drive shaft has a common bearing bushing for the first bearing, which is designed as a shaft bearing and is a part of the drive shaft, and for the housing bearing of the differential housing.

A differential arrangement, drawing on bevel gears, is also known from the U.S. Pat. No. 7,775,928 B2.

Furthermore, the patent DE 10 2009 017 397 A1 discloses a transmission arrangement that draws on planetary gears. The transmission arrangement, presented is this patent, relates to a differential gear unit comprising a drive-sided disk part; a first drive part, which is connected to a first driven axle in a rotationally rigid manner; and a second drive part, which is connected to a second driven axle in a rotationally rigid manner, wherein a toothed gear arrangement is provided between the first drive part and the second drive part for the purpose of transmitting torque from the drive-sided disk part to the first drive part and the second drive part. In this case the first drive part has the shape of a first drive disk and has a convexity, radially spaced apart from the first driven axle. Furthermore, the second drive part has the shape of a second drive disk that extends radially outwards from the second driven axle. Furthermore, the convexity points away from the second drive disk. The toothed gear arrangement is disposed in a space formed by the convexity of the first drive disk and the opposite region of the second drive disk.

Planetary gear units of this type, which are designed as differential gear units, can be designed as spur gear differentials, which are known, for example, from the patent WO 2010/112366 A1. The spur gear differential arrangement, presented in said patent, discloses the utilizability in a motor vehicle. In this case bevel toothed sun gears, planet gears, and a ring gear are used by a surrounding housing having bearings supported therein, in such a way that the parallel arranged sun gears are each coupled to parallel arranged output shafts. It is provided in this document that friction surfaces are arranged between the parallel arranged sun gears and/or between the sun gears and the surrounding housing.

It is possible to improve the known planetary gear units with respect to rigidity, load carrying capacity and friction. Thus, the object is, among other things, to make possible higher degrees of rigidity, higher load carrying capacities and lower coefficients of friction. Furthermore, the object is to achieve a small bearing cross section in order to reduce, in addition, the total weight. Furthermore, the object is to enable the use of at least one blank as a deep-drawn component.

### BRIEF SUMMARY OF THE INVENTION

The invention achieves this engineering object in a planetary gear unit conforming to its genre in that the inner bearing ring comprises a channel for enveloping a carrier element, such as a section of the housing or of the planet carrier.

Advantageous embodiments are claimed in the dependent claims and shall be explained in detail below.

Thus, it is also advantageous, if the channel is designed as a depression that extends around an axis of rotation.

Furthermore, it is useful if the channel is adapted to the shape of the carrier element with or without play, and if a form fit, force fit and/or material bond is impressed in-between.

One advantageous exemplary embodiment is also characterized in that the said bearing ring also forms at least one sliding surface, in order to come into sliding contact there with the sun gear. Then it is possible to integrate a sliding bearing in a sun gear by means of the bearing ring, which also includes a rolling raceway.

If a sliding surface, which is prepared to come into sliding contact with a surface of the sun gear, for example, an end face or an outer peripheral surface, is designed adjacent to a radially inner bearing ring end, then a particularly compact design is achieved.

It is also advantageous, when a bearing ring end of this type is designed on the outer bearing ring and when the sliding surface, which is disposed on said bearing ring end, communicates with the end face, and/or when such a bearing ring end is designed on the outer bearing ring, that the sliding surface, which is designed on the bearing ring end, communicates with the outer peripheral surface.

It is also worth mentioning that it is advantageous if the bearing ring end is configured to point into the interior of the planet carrier or is configured to point away from the interior of the planet carrier.

It is also advantageous, if a bearing ring end of the one bearing ring of the rolling bearing points in the one axial direction, and the bearing ring end of the other bearing ring of the same rolling bearing points in the opposite axial direction.

Furthermore, it is advantageous if the inner bearing ring or the outer bearing ring comprises the sliding surface.

One advantageous exemplary embodiment is also characterized in that the bearing ring has two sliding surfaces, of which the first sliding surface lies in a radial plane and the second sliding surface is oriented transversely, for example, orthogonally to the radial plane. In this way it is possible to ensure, on the one hand, a sliding bearing, acting in the radial direction, and, on the other hand, a sliding bearing, acting in the axial direction, so that the precision of the planetary gear unit is increased.

It is also practical for the first sliding surface to be able to come or to come into contact with an end face of the sun gear and for the second sliding surface to be able to come or to come into contact with an outer peripheral surface/shell surface of a section of the sun gear. Then, on the one hand, an undesired displacement, such as an axial shift of the sun gear, can be prevented, and a radial displacement is also eliminated as well. Since a relative movement of the sun gear towards the planet carrier will rarely occur, i.e., only if the output shafts move at different speeds with respect to each other, it is possible to provide an inexpensive bearing arrangement that has, nevertheless, an adequate load bearing capacity.

It is also advantageous if at least the bearing ring exhibiting the at least one sliding surface is designed as a deep drawn sheet metal component that is manufactured without machining. Such a metallic component can be manufactured inexpensively, even in large quantities, with the durability of such bearing rings being long.

If both bearing rings are made as deep drawn sheet metal components that are manufactured without machining, then the costs can be kept extremely low.

In this respect it is advantageous to attach two rolling bearings, which are similar or identical in design, to two sides of the planet carrier, in order to mount them on the housing in an X arrangement or, even better, O arrangement. The O arrangement makes it possible to achieve the objective of a bearing arrangement that is particularly tilt resistant, whereas in the case of an X arrangement the assembly is easier.

For the configuration of the planetary gear unit it is advantageous, if the rolling bodies are designed as balls, cones, barrels, disks or rollers, for example, as needles.

In this context it has proven to be advantageous if the rolling bodies are formed in the shape of a toroidal and/or part of a toroidal roller bearing.

One advantageous exemplary embodiment is also characterized in that the planetary gear unit is designed as a spur gear differential with two sun gears and two sets of planetary gears. In this case one sun gear is always in meshing engagement with the planet gears of one set of planetary gears; whereas the other sun gear engages with the planet gears of the other set of planetary gears. At the same time the planet gears of one set of planetary gears may also be in meshing engagement with the planet gears of the other set of planetary gears.

It has proven to be advantageous if the rollers are formed in the manner of a drum, for example, in the manner of straight solid or hollow cylinders, or have a spherical or bulging outer shape, for example, in the manner of a barrel.

Furthermore, it is advantageous if the rolling bearing is designed as an inclined bearing, for axial and radial mounting. In particular, inclined ball bearings can then serve a useful purpose.

It is also particularly efficient, if the longitudinal rolling bodies exhibit a constant convexity or a convexity that increases and decreases along the longitudinal axis of the rolling bodies.

It is advantageous, if the radius that determines the convexity has its origin radially outside the outer raceway for the rolling bodies; and/or the origin is present on a side of an axis of rotation of the rolling bearing that is opposite the respective rolling body.

Furthermore, it is advantageous if an outer raceway or an inner raceway for the rolling bodies, thus, one of the rolling raceways, for the rolling bodies, is formed by means of a deep drawn or deep drawable sheet metal component or by means of the planet carrier; and/or an inner raceway or an outer raceway is set like a solid, separate bearing shell or the stationary housing.

It is also worth mentioning that it is advantageous, if a rolling diameter of the, for example, barrel like rolling bodies, which is defined in terms of its convexity, for example, by the different radii, has at a maximum deviation of +/−10% the same diameter as a planetary bearing arrangement diameter that is determined by the radially inner-most planet gears; and/or the contact angle ranges from approximately 35° to approximately 55° and is, for example, approximately 45° in an almost optimal case.

It is also advantageous, if the outer bearing ring has a stiffening bead between a planet carrier contact region and a sun gear sliding contact region. Then the bearing component with the stiffening bead becomes particularly stiff and loadable.

In this case it is advantageous if the stiffening bead defines a cylindrical tube section of the outer bearing ring. This feature facilitates the production.

It is advantageous for the assembly if the cylindrical tube section is disposed axially between two additional cylindrical tube sections.

It is also worth mentioning that it is also advantageous if the planet carrier is held, for example, externally on the first of the two tube sections adjacent to the stiffening beads in a form fitting and/or force fitting way and/or can be brought slidingly into contact with the other one of the tube sections, adjacent to the two stiffening beads, for example, internally, in the region of the sun gear.

The inner bearing ring can be formed by extrusion. Furthermore, the inner bearing ring can have an axially protruding collar section, which can be brought into contact with the sun gear.

The planet carrier can have an axially protruding collar section, which can be brought into contact with the sun gear.

The outer bearing ring is designed advantageously as a one piece cold formed part with a raceway for a rolling body.

If the planet carrier extends radially further inwards than the inner bearing ring, then advantageous variants can be produced.

A cover, which has preferably a U-profile extending around a hole, can be disposed radially inside the planet carrier and/or the inner bearing ring.

It is also advantageous, if a friction disk is located between the sun gears.

The outer bearing ring may also be connected to the plant carrier in a form fitting, force fitting and/or firmly bonded way; and/or a connecting part, which connects the planet carrier to the rolling bearing, can be deep drawn.

In other words, a light weight differential is proposed that is supported on a carrier part on at least one bearing point, preferably on both bearing points. On the one hand, it is externally supported on a bearing; and, on the other hand, a sliding bearing arrangement is used for contact with the sun gears. Embodiments of the invention provide that the carrier part is an outer ring that includes the raceway of the rolling bodies of the bearing. It is possible to produce the carrier part without machining and to realize additional variants. Instead of an inclined ball bearing, it is also possible to use, in particular, barrel-shaped roller bearings.

Furthermore, the carrier part has three outer cylindrical surfaces, of which one defines the seat for the differential cage; one is a boundary of the sliding bearing section of the sun gears; and one central outer cylindrical surface is a bead-like stiffening.

Thus, flange bearings made of sheet metal can be provided with balls. The inner ring of the bearing can be designed as a standard solid component. The flange of the bearing is pressed on the flange of the light weight differential. The rolling diameter of the barrel-shaped roller bearing has the same diameter as the smaller diameter of the planet bearing arrangement with +/−10%. The contact angle is, for example, 45° (+/−10%). The outer ring of the bearing is formed as a deep drawn part. Said outer ring extends radially inwards as far as to below the diameter of the inner bearing ring. In this case the flange supports the output sun of the differential in the axial and/or radial direction. As a result, an axle drive in passenger cars can be improved. The flange bearing has a radial bearing and a sliding bearing, which is disposed radially further inwards, in order to support the output sun.

### BRIEF DESCRIPTION OF THE SEVERAL VIEWS OF THE DRAWINGS

The invention is explained in detail below by means of one drawing. At the same time different exemplary embodiments are described. The drawings show:

FIG. 1 is a first exemplary embodiment in a partially shown longitudinal sectional view;

FIG. 2 is an exploded view of the planet carrier of the first exemplary embodiment in the region of the rolling bearing, supporting said planet carrier and comprising rolling bodies;

FIG. 3 is a second exemplary embodiment in a view, comparable to that in FIG. 1, with an outer bearing ring that is more flexible than the outer bearing ring of the first exemplary embodiment;

FIG. 4 is the rolling bearing of the second exemplary embodiment in a single, enlarged view;

FIG. 5 is a third embodiment and a view comparable to that in FIGS. 1 and 3;

FIG. 6 is a fourth exemplary embodiment, where, in contrast to the third exemplary embodiment, the inner bearing ring does not have a channel for receiving the planet carrier, but rather the inner bearing ring has a channel for receiving the housing; and,

FIG. 7 is an exploded view of the region VII from FIG. 6.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

The figures are merely schematic in nature and, thus, only serve to better understand the invention. The same elements are provided with the same reference numerals. Features of the individual exemplary embodiments are interchangeable and/or may be combined.

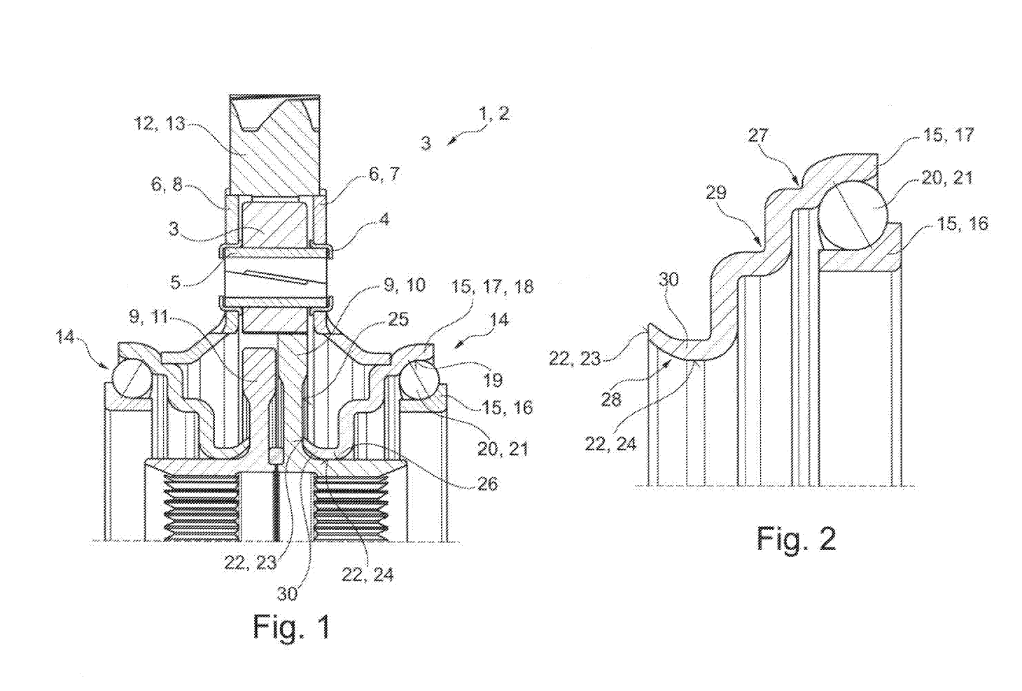

FIG. 1 shows a variant of a light weight differential/light weight spur gear differential with a combined sliding-rolling bearing, in particular, a first embodiment of planetary gear unit 1. Planetary gear unit 1 is designed as spur gear differential 2 for a passenger vehicle, a truck or any other type of commercial vehicle.

Two planet gear sets with plurality of planet gears 3 are used. Planet gears 3 are mounted by means of sleeves 4 and pins 5, which resemble hollow bolts, in planet carrier 6, which comprises first half 7 of the planet carrier and second half 8 of the planet carrier. The planet gears can mesh with sun gears 9. In this case planet gears 3 of the one set of planet gears mesh with first sun gear 10; and planet gears 3 of the other set of planet gears mesh with second sun gear 11. Planet carrier 6 is coupled to drive gear 12, i.e., spur gear 13, in a rotationally rigid manner.

Planet carrier 6 is mounted on a housing (not shown) by means of two rolling bearings 14, which are arranged in an O arrangement. The two rolling bearings 14 are identical in design. They have two bearing rings 15, in particular, inner bearing ring 16 and outer bearing ring 17. Inner bearing ring 16 can also be referred to as an inner bearing shell, whereas outer bearing ring 17 can be referred to as an outer bearing shell.

In principle, the two bearing rings 15 can be designed as a solid component; however, a combination of a metal component, which is produced without machining, i.e., a deep drawn component, in a milled component, which is produced as a solid component, as the bearing ring is advantageous. At least outer bearing ring 17 in the exemplary embodiment, shown in FIG. 1, is formed as a deep drawn sheet metal component 18.

Rolling raceway 19 is formed on a radial inner side. In the normal operating mode rolling bodies 21, designed as balls 20, roll on said rolling raceway. Extending axially in the direction of the other rolling bearing 14 and radially, further inwards than rolling raceway 19, sliding surface 22 is formed on the deep drawn sheet metal component 18. This sliding surface 22 is also referred to as second sliding surface 23. Sliding surface 24 is axially spaced apart, but closer to the other rolling bearing 14. The two sliding surfaces 22, i.e., second sliding surface 23 and first sliding surface 24, can come into contact with sun gear 9. In this case, second sliding surface 23 comes into sliding contact with end face 25 of the sun gear; and first sliding surface 24 comes into sliding contact with outer peripheral surface 26, thus, a shell surface of same sun gear 9.

It is clear from FIG. 2 when viewed together with FIG. 1 that outer bearing ring 17 has planet carrier contact region 27 as well as sun gear sliding contact region 28.

In-between there is stiffening bead 29. Outer bearing ring 17 is configured as a cylindrical tube section in the region of stiffening bead 29. In total, the results are three or even four radially and axially spaced cylindrical tube sections.

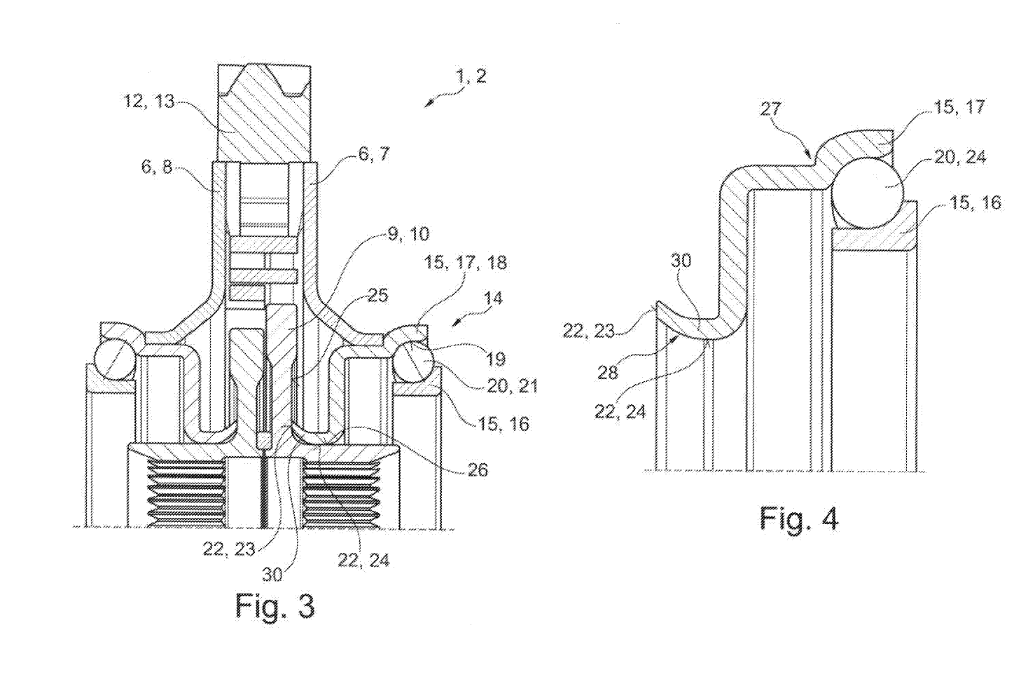

A second exemplary embodiment is shown in FIG. 3 with the difference being the absence of stiffening bead 29 on outer bearing ring 17. This situation can be seen very clearly in the enlarged view in FIG. 4. However, outer bearing ring 17 also has a radially inner end, which is configured as outwardly curved flange 30.

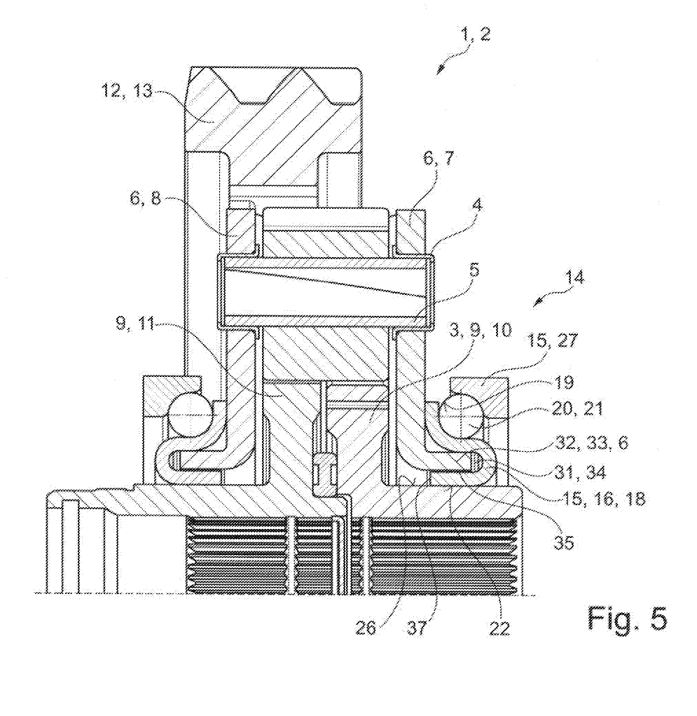

In the exemplary embodiment, shown in FIG. 5, inner bearing ring 16, which is formed as deep drawn sheet metal component 18, comprises both rolling raceway 19 and sliding surface 22. There is only one sliding surface 22, which comes into sliding contact with outer peripheral surface 26 in the manner of first sliding surface 24.

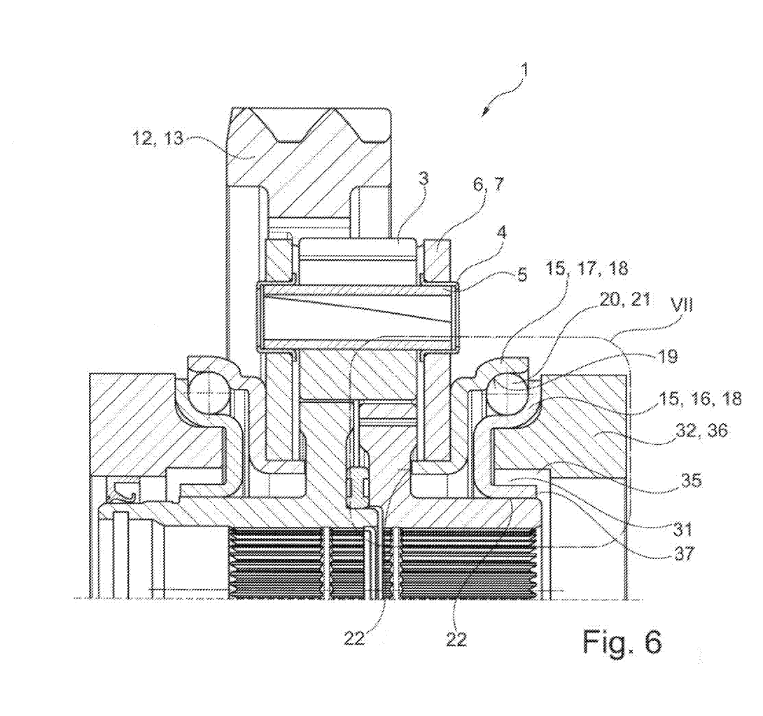

In the exemplary embodiments in FIGS. 5 and 6, inner bearing ring 16 comprises channel 31, with which a part of carrier element 32 engages. In the exemplary embodiment in FIG. 5, carrier element 32 is flange end 33 of planet carrier 6.

Channel 31 is designed as depression 34 extending around an axis of rotation. In this case flange end 33 fits, in addition to gap 35 on the radially inner side of flange end 33, exactly in channel 31. On the radially outer side of flange end 33, there is a press fit between inner bearing ring 16 and planet carrier 6.

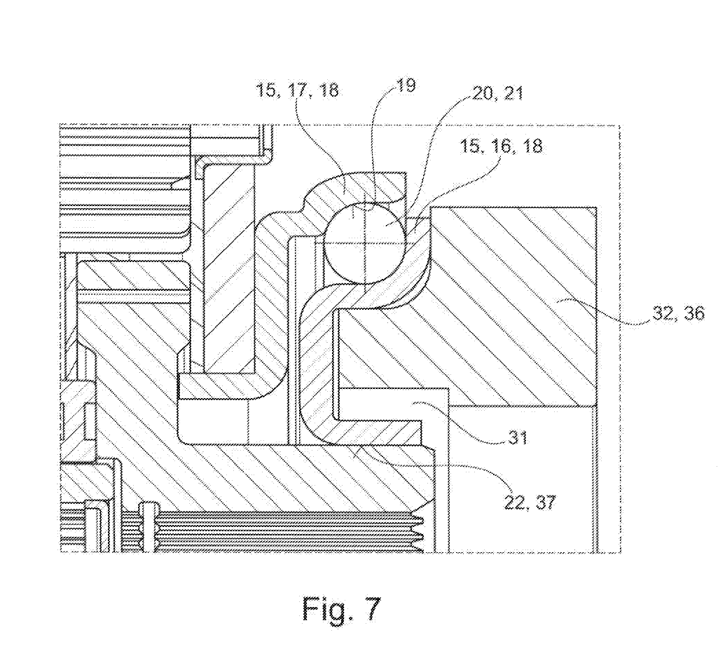

In contrast, as can be seen very clearly in FIGS. 6 and 7, channel 31, shown in the exemplary embodiment in FIGS. 6 and 7, is directed away from sun gear 9; and carrier element 32 is a part of housing 36. Another feature that differs from those shown in the exemplary embodiment in FIG. 5, is the design of two inner bearing rings 15, which are formed here as deep drawn sheet metal components 18. Whereas an X arrangement is chosen in the exemplary embodiment according to FIG. 5, an O arrangement is chosen in the exemplary embodiment according to FIG. 6.

In the exemplary embodiment according to FIG. 5, bearing ring end 37 on inner bearing ring 16 is configured to point towards sun gear 9, whereas it is configured to point away from sun gear 9 in the exemplary embodiment in FIGS. 6 and 7.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### LIST OF REFERENCE NUMERALS

1 planetary gear unit
2 spur gear differential
3 planet gear
4 sleeve
5 pin
6 planet carrier
7 first half of the planet carrier
8 second half of the planet carrier
9 sun gear
10 first sun gear
11 second sun gear
12 drive gear
13 spur gear
14 rolling bearing
15 bearing ring
16 inner bearing ring/inner bearing shell
17 outer bearing ring/outer bearing shell
18 deep drawn sheet metal component
19 rolling raceway
20 ball
21 rolling body
22 sliding surface
23 second sliding surface
24 first sliding surface
25 end face
26 outer peripheral surface
27 planet carrier contact region
28 sun gear sliding contact region
29 stiffening bead
30 flange
31 channel
32 carrier element
33 flange end
34 depression
35 gap
36 housing
37 bearing ring end

What is claimed is:

1-10. (canceled)

11. A planetary gear unit, such as a differential transmission, with a planet carrier, to which planet gears, which are in meshing engagement with at least one sun gear, are rotatably connected, where the planet carrier can be connected to a drive gear, such as a spur gear, where, furthermore, a rolling bearing having rolling bodies and two bearing rings, i.e., an inner bearing ring and an outer bearing ring, rotatably mounts the planet carrier on a stationary housing, such as a transmission housing, in such a way that said rolling bearing determines the axial and/or radial position; where at least one of the bearing rings forms a rolling raceway for the rolling bodies to roll thereon, wherein the inner bearing ring comprises a channel for enveloping a carrier element, such as a section of the housing or of the planet carrier.

12. The planetary gear unit as claimed in claim 11, wherein the channel is designed as a depression that extends around an axis of rotation.

13. The planetary gear unit as claimed in claim 11, wherein the channel is adapted to the shape of the carrier element; and a form fit, force fit and/or form fit is impressed in-between.

14. The planetary gear unit as claimed in claim 11, wherein a sliding surface, which is prepared to come into sliding contact with a surface of the sun gear, is designed adjacent to a radially inner bearing ring end.

15. The planetary gear unit as claimed in claim 14, wherein the radially inner bearing ring end is designed on the outer bearing ring; and the sliding surface, which is disposed on said bearing ring end, communicates with an end face of the sun gear; and/or the radially inner bearing ring end is designed on the outer bearing ring; that the sliding surface, which is designed on said bearing ring end, communicates with the outer peripheral surface of the sun gear.

16. The planetary gear unit as claimed in claim 14, wherein the bearing ring end is configured to point into the interior of the planet carrier or is configured to point away from the interior of the planet carrier.

17. The planetary gear unit as claimed in claim 14, wherein the bearing ring end of the one bearing ring of the rolling bearing points in the one axial direction; and the bearing ring end of the other bearing ring of the same rolling bearing points in the opposite axial direction.

18. The planetary gear unit as claimed in claim 11, wherein the rolling bodies are designed as balls, cones, barrels, disks or rollers.

19. The planetary gear unit as claimed in claim 11, wherein the rolling bodies are formed in the shape of a toroidal and/or part of a toroidal roller bearing.

20. The planetary gear unit as claimed in claim 11, wherein the planetary gear unit is designed as a spur gear differential with two sun gears and two sets of planet gears; and the two sun gears are connected by gearing via two respective planet gears.
